(19) United States
(12) Patent Application Publication
(10) Pub. No.: US 2009/0194214 A1
(43) Pub. Date: Aug. 6, 2009

(54) Tire and Crosslinkable Elastomeric Composition

(76) Inventors: Maurizio Galimberti, Milano (IT); Gaetano Guerra, Salerno (IT); Angela Lostritto, Caserta (IT)

Correspondence Address: Finnegan Henderson Farabow Garrett & Dunner, 901 New York Avenue N W, Washington, DC, 20001-4413, US

(21) Appl. No.: 12/308,221

(22) PCT Filed: Jun. 14, 2006
(86) PCT No.: PCT/EP2006/005720

§ 371 Date: Dec. 10, 2008

(51) Int. Cl. B60C 1/00; B60C 15/00; B32B 5/16; C08K 3/34; C08L 21/00

(52) U.S. Cl. 152/539; 428/339; 428/327

(57) ABSTRACT

A tire including at least one structural element including a crosslinked elastomeric material obtained by crosslinking a crosslinkable elastomeric composition including: (a) at least one elastomeric polymer; (b) at least one layered material, the layered material having an individual layer thickness of 0.2 nm to 30 nm, preferably 0.3 nm to 15 nm, more preferably 0.5 nm to 2 nm, wherein the layered material shows, in an X-ray powder diffraction pattern, an X-ray intensity ratio (R) defined according to the following formula: (R)=[A₍₀₀₁₎/A₍ₕₖ₀₎max]×100 wherein: A₍₀₀₁₎ is the area of the peak; A₍ₕₖ₀₎max is the area of the most intense peak (hk0), at least one of h or k being different from 0; lower than or equal to 20, preferably lower than or equal to 15, more preferably lower than or equal to 10, still more preferably lower than or equal to 5. Preferably, the at least one structural element is a tire tread band.

The present invention relates to a tire and to a crosslinkable elastomeric composition.

More particularly, the present invention relates to a tire comprising at least one structural element including a crosslinked elastomeric material obtained by crosslinking a crosslinkable elastomeric composition comprising at least one elastomeric polymer and at least one nanosized layered material.

Moreover, the present invention relates to a crosslinkable elastomeric composition comprising at least one elastomeric polymer and at least one nanosized layered material, as well as to a crosslinked manufactured article obtained by crosslinking said crosslinkable elastomeric composition.

In the rubber industry, in particular that of tires, it is known practice to add layered materials to crosslinkable elastomeric compositions, in order to improve their mechanical properties, both static and dynamic.

For example, European Patent Application EP 1,193,085 relates to a tire with a rubber/cord laminate, sidewall insert and apex including a rubber composition comprising, based upon parts by weight of an ingredient per 100 parts by weight elastomer (phr):
(A) 100 phr of at least one diene-base elastomer;
(B) 30 phr to 100 phr of particulate reinforcement dispersed within said elastomer(s) selected from intercalated smectite, preferably montmorillonite, clay particles, carbon black, synthetic amorphous silica and silica treated carbon black, comprised of:
   (1) 1 phr to 10 phr of said intercalated, layered, thin, substantially two dimensional smectite, preferably montmorillonite, clay particles of which at least a portion thereof is in a form of thin, flat, substantially two dimensional exfoliated platelets derived from said intercalated clay; and
   (2) 20 phr to 99 phr of at least one additional reinforcing filler comprised of carbon black, synthetic amorphous silica and silica treated carbon black.

The abovementioned rubber composition is said to have improved stiffness and tensile modulus with only a small increase of Tan delta values.

United States Patent Application 2003/0004250 relates to a light weight rubber composition comprising (1) an amino group containing rubbery polymer, wherein said amino group containing rubbery polymer contains from about 0.1 weight percent to about 20 weight percent of a monomer containing an amino group, and (2) from about 0.1 phr to about 25 phr of a 2:1 layered silicate clay. The abovementioned rubber composition, having improved tensile strength and elongation at break, is said to be useful in the manufacturing of rubber articles such as power transmission belts and tires, in particular tire tread band and sidewalls.

United States Patent Application US 2002/0095008 relates to a sulfur-curable rubber compound for a tire tread rubber, in particular tire tread rubber for racing tires, comprising at least one diene rubber, at least one filler, and at least one plasticizer, wherein the rubber compound comprises from 5 phr to 90 phr of at least one layered silicate modified with alkylammonium ions and free of guest molecules that have been polymerized or swelled in by a prior treatment. The abovementioned rubber compound is said to provide high skid resistance (high friction coefficient, good grip) of the tires made therefrom, combined with a reduction in hardness at elevated temperatures.

International Patent Application WO 05/002883 in the name of the Applicant, relates to a tire of a cap and base construction, comprising:
a carcass structure with at least one carcass ply shaped in a substantially toroidal configuration, the opposite lateral edges of which are associated with respective right-hand and left-hand bead wires, each bead wire being enclosed in a respective bead;
a belt structure comprising at least one belt strip applied in a circumferentially external position relative to said carcass structure;
a tread band superimposed circumferentially on said belt structure comprising a radially outer layer designed to come into contact with the ground and a radially inner layer interposed between said radially outer layer and said belt structure;
a pair of sidewalls applied laterally on opposite sides relative to said carcass structure;
   wherein said radially inner layer includes a crosslinked elastomeric composition comprising:
(a) at least one diene elastomeric polymer;
(b) at least one layered inorganic material having an individual layer thickness of from 0.01 nm to 30 nm, preferably of from 0.05 nm to 15 nm, said layered inorganic material being present in an amount of from 1 phr to 120 phr, preferably of from 5 phr to 80 phr.

The addition of said layered inorganic material is said to increase the mechanical properties of the elastomeric composition without observing undesired effects on its remaining properties (i.e. viscosity, hysteresis, green adhesiveness).

However, the Applicant has noticed that the use of said layered materials may cause some drawbacks.

In particular, the Applicant has noticed that said elastomeric compositions may have a high dinamic elastic modulus (E′) at low temperatures, and that, said dinamic elastic modulus (E′), tends to remarkably decrease as the temperature increases thus causing a “thermoplastic behaviour” of said crosslinkable elastomeric compositions (i.e., a remarkable difference in the elastic performance qualities of said crosslinkable elastomeric compositions over a wide temperatures ranges). Moreover, the Applicant has noticed that said crosslinkable elastomeric compositions usually have a low tear resistance.

The Applicant has now found that it is possible to overcome the abovementioned drawbacks, by adding to the crosslinkable elastomeric compositions at least one nanosized layered material showing, in a X-ray powder diffraction (XRPD) pattern, the characteristics below reported. The so obtained crosslinkable elastomeric compositions may be advantageously used in the production of crosslinked manufactured products, in particular in the manufacturing of tires, more in particular in a tire tread band. The addition of said nanosized layered material allows to obtain crosslinkable elastomeric compositions showing low dinamic elastic modulus (E′) at low temperatures and a reduced variation of said dynamic elastic modulus (E′) as the temperatures increases (i.e., a reduced “thermoplastic behaviour”). Moreover, said crosslinkable elastomeric compositions show improved tear resistance. Furthermore, said crosslinkable elastomeric compositions show improved dynamic elastic modulus (G′) measured at both low deformations (3%) and high deformations (10%).

According to a first aspect, the present invention relates to a tire comprising at least one structural element including a crosslinked elastomeric material obtained by crosslinking a crosslinkable elastomeric composition comprising:
(a) at least one elastomeric polymer;
(b) at least one layered material, said layered material having an individual layer thickness of from 0.2 nm to 30 nm, preferably of from 0.3 nm to 15 nm, more preferably of from 0.5 nm to 2 nm;
   wherein said layered material shows, in a X-ray powder diffraction (XRPD) pattern, a X-ray intensity ratio (R) defined according to the following formula:

(R)=[A₍₀₀₁₎/A₍ₕₖ₀₎ₘₐₓ]×100

wherein:
A₍₀₀₁₎ is the area of the peak (001);
A₍ₕₖ₀₎ₘₐₓ is the area of the most intense peak (hk0), at least one of h or k being different from 0; lower than or equal to 20, preferably lower than or equal to 15, more preferably lower than or equal to 10, still more preferably lower than or equal to 5.

According to one preferred embodiment, the tire comprises:
a carcass structure of a substantially toroidal shape, having opposite lateral edges associated with respective right-hand and left-hand bead structures, said bead structures comprising at least one bead core and at least one bead filler;
a belt structure applied in a radially external position with respect to said carcass structure;
a tread band radially superimposed on said belt structure;
a pair of sidewalls applied laterally on opposite sides with respect to said carcass structure;
   wherein said structural element is a tread band.

According to a further aspect, the present invention relates to a crosslinkable elastomeric composition comprising:
(a) at least one elastomeric polymer;
(b) at least one layered material, said layered material having an individual layer thickness of from 0.2 nm to 30 nm, preferably of from 0.3 nm to 15 nm, more preferably of from 0.5 nm to 2 nm;
   wherein said layered material shows, in a X-ray powder diffraction (XRPD) pattern, a X-ray intensity ratio (R) defined according to the following formula:

(R)=[A₍₀₀₁₎/A₍ₕₖ₀₎ₘₐₓ]×100

wherein:
A₍₀₀₁₎ is the area of the peak (001);
A₍ₕₖ₀₎ₘₐₓ is the area of the most intense peak (hk0), at least one of h or k being different from 0;
   lower than or equal to 20, preferably lower than or equal to 15, more preferably lower than or equal to 10, still more preferably lower than or equal to 5.

According to one preferred embodiment, said layered material shows, in a X-ray powder diffraction (XRPD) pattern, a delamination index (DI) higher than or equal to 10%, preferably higher than or equal to 50%, more preferably higher than or equal to 90%, said delamination index being defined according to the following formula:

(DI)=[1−(I₀₀₁/I⁰₀₀₁)]×100

wherein:
I₍₀₀₁₎ is the intensity of the peak (001) of the mechanically treated layered material;
I⁰₍₀₀₁₎ is the intensity of the peak (001) of the non-mechanically treated layered material;
   said I₍₀₀₁₎ and I⁰₍₀₀₁₎ being defined by the following formulae:

I₍₀₀₁₎=A₍₀₀₁₎/A₍ₕₖ₀₎

I⁰₍₀₀₁₎=A^{o}₍₀₀₁₎/A⁰₍ₕₖ₀₎

wherein:
A₍₀₀₁₎ is the area of the peak (001) of the mechanically treated layered material;
A⁰₍₀₀₁₎ is the area of the peak (001) of the non-mechanically treated layered material;
A₍ₕₖ₀₎ is the area of a peak (hk0), preferably of the most intense peak (hk0), at least one of h or k being different from 0, of the mechanically treated layered material;
A⁰₍ₕₖ₀₎ is the area of a peak (hk0), preferably of the most intense peak (hk0), at least one of h or k being different from 0, of the non-mechanically treated layered material.

The X-ray powder diffraction (XRPD) pattern was modelled using polarization and Lorentz factors by using the following formula:

I_{cor.}=I_{exp.}/{[(1+cos²2θ)/2)]×[(sen²θ×cos θ)/2]}

wherein I_{cor.} is the corrected peak intensity and I_{exp.} is the peak experimental intensity, as reported, for example, by Harold P. Klug and Leroy E. Alexander and in: “X-Ray Diffraction Procedures for Polycrystalline and Amorphous Materials”, 2^{nd} Edition (1974), Wiley-Interscience Publication, pg. 142-144.

The X-ray powder diffraction (XRPD) analysis may be carried out by methods known in the art: further details about said analysis will be given in the examples reported hereinafter.

According to a further preferred embodiment, said layered material has a BET surface area, measured according to Standard ISO 5794-1:2005, of from 1 m²/g to 200 m²/g, preferably of from 2 m²/g to 150 m²/g, still more preferably of from 3 m²/g to 110 m²/g.

According to a further preferred embodiment, said layered material has an average particle size (D50) lower than or equal to 70 μm, preferably lower than or equal to 30 μm, more preferably lower than or equal to 10 μm, still more preferably lower than or equal to 5 μm.

The average particle size (D50) may be measured according to methods known in the art such as, for example, by means of a particle size analyzer (e.g., Sedigraph 5100 from Micrometrics Instrument Corp.): further details about said analysis will be given in the examples reported hereinafter.

According to a further preferred embodiment, said crosslinkable elastomeric composition may further comprise (c) at least one silane coupling agent.

According to a further preferred embodiment, said crosslinkable elastomeric composition may further comprise (d) at least one alkylammonium or alkyl phosphonium salt.

According to a still further aspect, the present invention relates to a crosslinked manufactured article obtained by crosslinking the crosslinkable elastomeric composition above reported.

For the purpose of the present description and of the claims which follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

According to one preferred embodiment, said elastomeric polymer (a) may be selected, for example, from (a₁) diene elastomeric polymers which are commonly used in sulfur-crosslinkable elastomeric compositions, that are particularly suitable for producing tires, that is to say from elastomeric polymers or copolymers with an unsaturated chain having a glass transition temperature (T_{g}) generally below 20° C., preferably in the range of from 0° C. to −110° C. These polymers or copolymers may be of natural origin or may be obtained by solution polymerization, emulsion polymerization or gas-phase polymerization of one or more conjugated diolefins, optionally blended with at least one comonomer selected from monovinylarenes and/or polar comonomers. Preferably, the obtained polymers or copolymers contain said at least one comonomer selected from monovinylarenes and/or polar comonomers in an amount of not more than 60% by weight.

The conjugated diolefins generally contain from 4 to 12, preferably from 4 to 8 carbon atoms, and may be selected, for example, from: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene, or mixtures thereof. 1,3-butadiene or isoprene are particularly preferred.

Monovinylarenes which may optionally be used as comonomers generally contain from 8 to 20, preferably from 8 to 12 carbon atoms, and may be selected, for example, from: styrene; 1-vinylnaphthalene; 2-vinylnaphthalene; various alkyl, cycloalkyl, aryl, alkylaryl or arylalkyl derivatives of styrene such as, for example, α-methylstyrene, 3-methylstyrene, 4-propylstyrene, 4-cyclohexylstyrene, 4-dodecylstyrene, 2-ethyl-4-benzylstyrene, 4-p-tolylstyrene, 4-(4-phenylbutyl)styrene, or mixtures thereof. Styrene is particularly preferred.

Polar comonomers which may optionally be used may be selected, for example, from: vinylpyridine, vinylquinoline, acrylic acid and alkylacrylic acid esters, nitriles, or mixtures thereof, such as, for example, methyl acrylate, ethyl acrylate, methyl methacrylate, ethyl methacrylate, acrylonitrile, or mixtures thereof.

Preferably, said diene elastomeric polymer (a₁) may be selected, for example, from: cis-1,4-polyisoprene (natural or synthetic, preferably natural rubber), 3,4-polyisoprene, polybutadiene (in particular, polybutadiene with a high 1,4-cis content), optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

Alternatively, said elastomeric polymer (a) may be selected, for example, from (a₂) elastomeric polymers of one or more monoolefins with an olefinic comonomer or derivatives thereof. The monoolefins may be selected, for example, from: ethylene and α-olefins generally containing from 3 to 12 carbon atoms, such as, for example, propylene, 1-butene, 1-pentene, 1-hexene, 1-octene, or mixtures thereof. The following are preferred: copolymers between ethylene and an α-olefin, optionally with a diene; isobutene homopolymers or copolymers thereof with small amounts of a diene, which are optionally at least partially halogenated. The diene optionally present generally contains from 4 to 20 carbon atoms and is preferably selected from: 1,3-butadiene, isoprene, 1,4-hexadiene, 1,4-cyclohexadiene, 5-ethylidene-2-norbornene, 5-methylene-2-norbornene, vinylnorbornene, or mixtures thereof. Among these, the following are particularly preferred: ethylene/propylene copolymers (EPR) or ethylene/propylene/diene copolymers (EPDM); polyisobutene; butyl rubbers; halobutyl rubbers, in particular chlorobutyl or bromobutyl rubbers; or mixtures thereof.

Mixtures of the abovementioned diene elastomeric polymers (a₁) with the abovementioned elastomeric polymers (a₂), may also be used.

The above reported elastomeric polymers (a) may optionally be functionalized by reaction with suitable terminating agents or coupling agents. In particular, the diene elastomeric polymers (a₁) obtained by anionic polymerization in the presence of an organometallic initiator (in particular an organolithium initiator) may be functionalized by reacting the residual organometallic groups derived from the initiator with suitable terminating agents or coupling agents such as, for example, imines, carbodiimides, alkyltin halides, substituted benzophenones, alkoxysilanes or aryloxysilanes (see, for example, European Patent EP 451,604, or U.S. Pat. No. 4,742,124, or U.S. Pat. No. 4,550,142).

The above reported elastomeric polymers (a) may optionally include at least one functional group which may be selected, for example, from: carboxylic groups, carboxylate groups, anhydride groups, ester groups, epoxy groups, or mixtures thereof.

According to one preferred embodiment, said layered material (b) may be obtained by milling at least one pristine layered material, i.e. the layered material not treated with any modifying agent such as, for example, alkyl ammonium or alkyl phosphonium salts.

According to a further preferred embodiment, said layered material (b) may be obtained by milling at least one layered material modified with at least one alkyl ammonium or alkyl phosphonium salt.

According to a further preferred, said layered material (b) may be obtained by milling a mixture comprising:
at least one pristine layered material;
at least one alkyl ammonium or alkyl phosphonium salt.

According to one preferred embodiment, said milling is a dry milling.

For the purposes of the present invention and of the claims which follow, the expression “dry milling” means that the milling is carried out in substantial absence of any liquid components such as, for example, water, solvents, or mixtures thereof (i.e., if present, said liquid components are present in an amount lower than 10% by weight with respect to the total weight of the layered material to be milled).

According to one preferred embodiment, said milling is carried out at a temperature of from −100° C. to +60° C., preferably of from +0° C. to +50° C. The time of milling depends on the power of the grinder or milling device used and, therefore, may vary within wide limits, anyway it should be sufficient to obtain a layered material showing, in a X-ray powder diffraction (XRPD) pattern, the characteristics above reported. For example, the milling is carried out for a time of from 3 min to 300 hours, preferably of from 10 min to 250 hours.

Any conventional grinder or milling device which is capable of providing sufficient power to effect fracture of the compounds to be comilled may be used according to the present invention. Preferably, planetary ball-mill, centrifugal ball-mill are used. Centrifugal ball-mill is particularly preferred.

According to one preferred embodiment, said layered material may be selected, for example, from phyllosilicates such as: smectites, for example, montmorillonite, bentonite, nontronite, beidellite, volkonskoite, hectorite, saponite, sauconite; vermiculite; halloisite; sericite; aluminate oxides; hydrotalcite; or mixtures thereof. Montmorillonite is particularly preferred. These layered material generally contains exchangeable cations such as sodium (Na⁺), calcium (Ca²⁺), potassium (K⁺), or magnesium (Mg²⁺), present at the interlayer surfaces.

Examples of layered materials which may be used according to the present invention and are available commercially are the products known by the name of Dellite® 67G, Dellite® HPS, Dellite® 72T, Dellite® 43B, from Laviosa Chimica Mineraria S.p.A.; Cloisite® Na, Cloisite® 25A, Cloisite® 10A, Cloisite® 15A, Cloisite® 20A, from Southern Clays; Nanofil® 5, Nanofil® 8, Nanofil® 9, from Süd Chemie; Bentonite® AG/3 from Dal Cin S.p.A.

According to one preferred embodiment, said alkyl ammonium or alkyl phosphonium salt may be selected, for example, from quaternary ammonium or phosphonium salts having general formula (I):

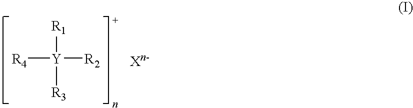

wherein:
Y represents N or P;
R₁, R₂, R₃ and R₄, which may be equal or different from each other, represent a linear or branched C₁-C₂₀ alkyl or hydroxyalkyl group; a linear or branched C₁-C₂₀ alkenyl or hydroxyalkenyl group;
a group —R₅—SH or —R₅—NH wherein R₅ represents a linear or branched C₁-C₂₀ alkylene group; a C₆-C₁₈ aryl group; a C₇-C₂₀ arylalkyl or alkylaryl group; a C₅-C₁₈ cycloalkyl group, said cycloalkyl group possibly containing hetero atom such as oxygen, nitrogen or sulfur;
xⁿ⁻ represents an anion such as the chloride ion, the sulphate ion or the phosphate ion;
n represents 1, 2 or 3.

Said alkyl ammonium or alkyl phosphonium salt is capable of undergoing ion exchange reactions with the ions which, as already disclosed above, are present at the interlayers surfaces of the layered materials.

In the case of using a layered material modified with at least one alkyl ammonium or alkyl phosphonium salt, its modification may be carried out by treating said layered material with at least one alkyl ammonium or alkyl phosphonium salt before subjecting it to a milling process above disclosed.

The treatment of the layered material with the at least one alkyl ammonium or alkyl phosphonium salt may be carried out according to known methods such as, for example, by an ion exchange reaction between the layered material and the at least one alkyl ammonium or alkyl phosphonium salt: further details about said treatment may be found, for example, in U.S. Pat. No. 4,136,103, U.S. Pat. No. 5,747,560, or U.S. Pat. No. 5,952,093.

According to one preferred embodiment, said at least one layered material (b) is present in the crosslinkable elastomeric composition in an amount of from 3 phr to 120 phr, preferably of from 5 phr to 80 phr.

For the purposes of the present description and of the claims which follow, the term “phr” means the parts by weight of a given component of the crosslinkable elastomeric composition per 100 parts by weight of the elastomeric polymer(s).

As disclosed above, said crosslinkable elastomeric composition may further comprise (c) at least one silane coupling agent.

According to one preferred embodiment, said silane coupling agent may be selected from those having at least one hydrolizable silane group which may be identified, for example, by the following general formula (II):

(R)₃Si—CₙH₂ₙ—X (II)

wherein the groups R, which may be equal or different from each other, are selected from: alkyl, alkoxy or aryloxy groups or from halogen atoms, on condition that at least one of the groups R is an alkoxy or aryloxy group; n is an integer of from 1 to 6, extremes included; X is a group selected from: nitroso, mercapto, amino, epoxide, vinyl, imide, chloro, —(S)ₘCₙH₂ₙ—Si—(R)₃, or —S—COR, wherein m and n are integers of from 1 to 6, extremes included and the groups R are defined as above.

Among the silane coupling agents that are particularly preferred are bis(3-triethoxysilyl-propyl)tetrasulphide, bis(3-triethoxysilylpropyl)-disulphide, 3-octanoylthio-1-propyltriethoxysilane, 3-aminopropyltriethoxysilane. Said coupling agents may be used as such or as a suitable mixture with an inert filler (for example, carbon black) so as to facilitate their incorporation into the elastomeric polymer.

According to one preferred embodiment, said silane coupling agent (c) is present in the crosslinkable elastomeric composition in an amount of from 0 phr to 25 phr, preferably of from 0.5 phr to 10 phr, more preferably of from 1 phr to 5 phr.

As disclosed above, said crosslinkable elastomeric composition may further comprise (d) at least one alkyl ammonium or alkyl phosphonium salt.

According to one preferred embodiment, said at least one alkyl ammonium or alkyl phosphonium salt (d) may be selected from those having general formula (I) above disclosed.

According to one preferred embodiment, said alkyl ammonium or alkyl phosphonium salt (d) is present in the crosslinkable elastomeric composition in an amount of from 6 phr to 50 phr, preferably of from 0.5 phr to 20 phr, more preferably of from 1 phr to 10 phr.

Examples of alkyl ammonium or alkyl phosphonium salt which may be used according to the present invention and are available commercially are the products known by the name of Arquad® HC Pastilles, Arquad® 2HT-75, Arquad® MC-50, Duoquad® T-50, from Akzo Nobel, or Bardac® LF 70 from Lonza.

At least one reinforcing filler may advantageously be added to the crosslinkable elastomeric composition above disclosed, in an amount generally of from 0 phr to 120 phr, preferably of from 10 phr to 90 phr. The reinforcing filler may be selected from those commonly used for crosslinked manufactured products, in particular for tires, such as, for example, carbon black, silica, alumina, aluminosilicates, calcium carbonate, kaolin, or mixtures thereof.

The types of carbon black which may be used according to the present invention may be selected from those conventionally used in the production of tires, generally having a surface area of not less than 20 m²/g (determined by CTAB absorption as described in ISO standard 6810).

The silica which may be used according to the present invention may generally be a pyrogenic silica or, preferably, a precipitated silica, with a BET surface area (measured according to Standard ISO 5794-1:2005) of from 50 m²/g to 500 m²/g, preferably of from 70 M²/g to 200 m²/g.

When a reinforcing filler comprising silica is present, the crosslinkable elastomeric composition may advantageously incorporate a further silane coupling agent capable of interacting with silica and of linking it to the elastomeric polymer(s) during the vulcanization. Examples of silane coupling agents which may be used have been already disclosed above.

The crosslinkable elastomeric composition above disclosed may be vulcanized according to known techniques, in particular with sulfur-based vulcanizing systems commonly used for elastomeric polymer(s). To this end, in the composition, after one or more steps of thermomechanical processing, a sulfur-based vulcanizing agent is incorporated together with vulcanization accelerators. In the final processing step, the temperature is generally kept below 120° C. and preferably below 100° C., so as to avoid any unwanted pre-crosslinking phenomena.

The vulcanizing agent most advantageously used is sulfur, or molecules containing sulfur (sulfur donors), with accelerators and activators known to those skilled in the art.

Activators that are particularly effective are zinc compounds, and in particular ZnO, ZnCO₃, zinc salts of saturated or unsaturated fatty acids containing from 8 to 18 carbon atoms, such as, for example, zinc stearate, which are preferably formed in situ in the elastomeric composition from ZnO and fatty acid, and also BiO, PbO, Pb₃O₄, PbO₂, or mixtures thereof.

Accelerators that are commonly used may be selected, for example, from: dithiocarbamates, guanidine, thiourea, thiazoles, sulphenamides, thiurams, amines, xanthates, or mixtures thereof.

Said crosslinkable elastomeric composition may comprise other commonly used additives selected on the basis of the specific application for which the composition is intended. For example, the following may be added to said crosslinkable elastomeric composition: antioxidants, anti-ageing agents, plasticizers, adhesives, anti-ozone agents, modifying resins, fibres (for example Kevlar® pulp), or mixtures thereof.

Moreover, for the purpose of further improving the processability, a plasticizer generally selected from mineral oils, vegetable oils, synthetic oils, or mixtures thereof, such as, for example, aromatic oil, naphthenic oil, phthalates, soybean oil, or mixtures thereof, may be added to said crosslinkable elastomeric composition. The amount of plasticizer generally ranges of from 0 phr to 70 phr, preferably of from of 5 phr to 30 phr.

The above reported crosslinkable elastomeric composition may be prepared by mixing together the elastomeric polymer(s) and the layered material with the reinforcing filler and the other additives optionally present, according to techniques known in the art. The mixing may be carried out, for example, using an open mixer of open-mill type, or an internal mixer of the type with tangential rotors (Banbury) or with interlocking rotors (Intermix), or in continuous mixers of Ko-Kneader type (Buss), or of co-rotating or counter-rotating twin-screw type.

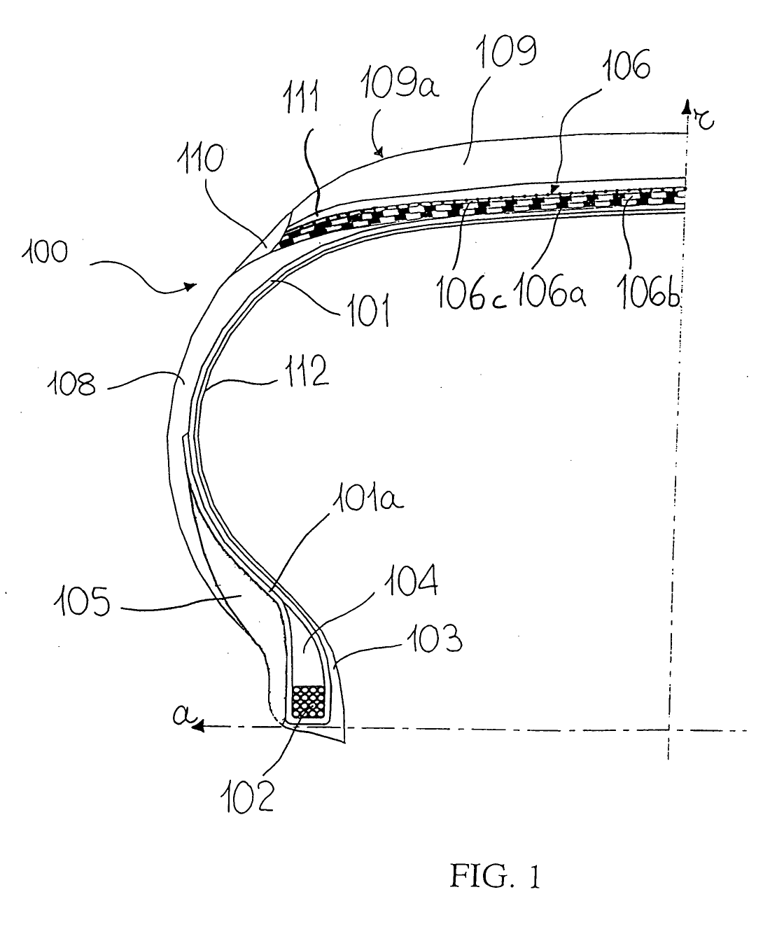

The present invention will now be illustrated in further detail by means of an illustrative embodiment, with reference to the attached FIG. 1 which is a view in cross section of a portion of a tire made according to the invention.

“a” indicates an axial direction and “r” indicates a radial direction. For simplicity, FIG. 1 shows only a portion of the tire, the remaining portion not represented being identical and symmetrically arranged with respect to the radial direction “r”.

The tire (100) comprises at least one carcass ply (101), the opposite lateral edges of which are associated with respective bead structures comprising at least one bead core (102) and at least one bead filler (104). The association between the carcass ply (101) and the bead core (102) is achieved here by folding back the opposite lateral edges of the carcass ply (101) around the bead core (102) so as to form the so-called carcass back-fold (101a) as shown in FIG. 1.

Alternatively, the conventional bead core (102) may be replaced with at least one annular insert formed from rubberized wires arranged in concentric coils (not represented in FIG. 1) (see, for example, European Patent Applications EP 928,680 or EP 928,702, both in the name of the Applicant). In this case, the carcass ply (101) is not back-folded around said annular inserts, the coupling being provided by a second carcass ply (not represented in FIG. 1) applied externally over the first.

The carcass ply (101) generally consists of a plurality of reinforcing cords arranged parallel to each other and at least partially coated with a layer of a crosslinked elastomeric material. These reinforcing cords are usually made of textile fibres, for example rayon, nylon or polyethylene terephthalate, or of steel wires stranded together, coated with a metal alloy (for example copper/zinc, zinc/manganese, zinc/molybdenum/cobalt alloys and the like).

The carcass ply (101) is usually of radial type, i.e., it incorporates reinforcing cords arranged in a substantially perpendicular direction relative to a circumferential direction. The bead core (102) is enclosed in a bead (103), defined along an inner circumferential edge of the tire (100), with which the tire engages on a rim (not represented in FIG. 1) forming part of a vehicle wheel. The space defined by each carcass back-fold (101a) contains a bead filler (104) wherein the bead core (102) is embedded. An antiabrasive strip (105) is usually placed in an axially external position relative to the carcass back-fold (101a).

A belt structure (106) is applied along the circumference of the carcass ply (101). In the particular embodiment in FIG. 1, the belt structure (106) comprises two belt strips (106a, 106b) which incorporate a plurality of reinforcing cords, typically metal cords, which are parallel to each other in each strip and intersecting with respect to the adjacent strip, oriented so as to form a predetermined angle relative to a circumferential direction. On the radially outermost belt strip (106b) may optionally be applied at least one zero-degree reinforcing layer (106c), commonly known as a “0° belt”, which generally incorporates a plurality of reinforcing cords, typically textile cords, arranged at an angle of a few degrees relative to a circumferential direction, and coated and welded together by means of a crosslinked elastomeric material.

A side wall (108) is also applied externally onto the carcass ply (101), this side wall extending, in an axially external position, from the bead (103) to the end of the belt structure (106).

A tread band (109), which may be made according to the present invention, whose lateral edges are connected to the side walls (108), is applied circumferentially in a position radially external to the belt structure (106). Externally, the tread band (109) has a rolling surface (109a) designed to come into contact with the ground. Circumferential grooves which are connected by transverse notches (not represented in FIG. 1) so as to define a plurality of blocks of various shapes and sizes distributed over the rolling surface (109a) are generally made in this surface (109a), which is represented for simplicity in FIG. 1 as being smooth.

A tread underlayer (111) is placed between the belt structure (106) and the tread band (109).

As represented in FIG. 1, the tread underlayer (111) may have uniform thickness.

Alternatively, the tread underlayer (111) may have a variable thickness in the transversal direction. For example, the thickness may be greater near its outer edges than at a central zone.

In FIG. 1, said tread underlayer (111) extends over a surface substantially corresponding to the surface of development of said belt structure (106). Alternatively, said tread underlayer (111) extends only along at least one portion of the development of said belt structure (106), for instance at opposite side portions of said belt structure (106) (not represented in FIG. 1).

A strip made of elastomeric material (110), commonly known as a “mini-side wall”, may optionally be present in the connecting zone between the side walls (108) and the tread band (109), this mini-side wall generally being obtained by co-extrusion with the tread band and allowing an improvement in the mechanical interaction between the tread band (109) and the side walls (108). Alternatively, the end portion of the side wall (108) directly covers the lateral edge of the tread band (109).

In the case of tubeless tires, a rubber layer (112) generally known as a liner, which provides the necessary impermeability to the inflation air of the tire, may also be provided in an inner position relative to the carcass ply (101).

The process for producing the tire according to the present invention may be carried out according to methods and using apparatus that are known in the art, as described, for example, in European Patents EP 199,064, or in U.S. Pat. No. 4,872,822 or U.S. Pat. No. 4,768,937, said process including manufacturing the crude tire, and subsequently moulding and vulcanizing the crude tire.

Although the present invention has been illustrated specifically in relation to a tire, other crosslinked elastomeric manufactured products that can be produced according to the invention may be, for example, conveyor belts, drive belts, or hoses.

The present invention will be further illustrated below by means of a number of illustrative examples, which are given for purely indicative purposes and without any limitation of this invention.

### EXAMPLE 1

### Preparation of the Layered Material

10.0 g of Cloisite® Na (natural montmorillonite belonging to the smectite family from Southern Clay S.p.A.) were added to a 0.300 l centrifugal ball-mill (Eatchs type, from Italscientifica S.p.A.), loaded with 2 ceramic balls having a diameter of 29.4 mm and 2 ceramic balls having 18.6 mm diameter. The mixture was ground, for 240 hours, with a rotating speed of 102 rpm, at ambient temperature (23° C.). 9.5 g of solid product were obtained.

The obtained powder was subjected to a average particle size measurement. To this aim 6 g of the obtained powder was dispersed in 60 ml of isopropyl alcohol and was maintained under stirring, at room temperature (23° C.), for 3 hours. The obtained dispersion was loaded to a particle size analyzer (Micrometric Sedigraph 5100). The average particle size (D50) was 21 μm (D50 means that 50% by weight of the particles has a particle hydrodynamic size not higher than or equal to 21 μm).

Moreover, the BET surface area of the obtained powder was measured according to Standard ISO 5794-1:2005. The BET surface area was 99 m²/g.

The obtained product was subjected to X-ray powder diffraction (XRPD) analysis. The analysis was performed by using a Bruker D8 automatic diffractometer for powder, equipped with Göbel-mirror monochromator.

Instrumental and measuring conditions were the following: CuKα radiation; 40 kV/20 mA voltage/current; divergence and detector slits of 1.0°, 0.6° and 0.8°, 0.05° 2θ step, using a time for step of 3 s; diffraction angle (2θ) from 2° to 80°.

For comparative purposes, a sample of a non-mechanically treated Cloisite® Na was subjected to a X-ray powder diffraction (XRPD) analysis.

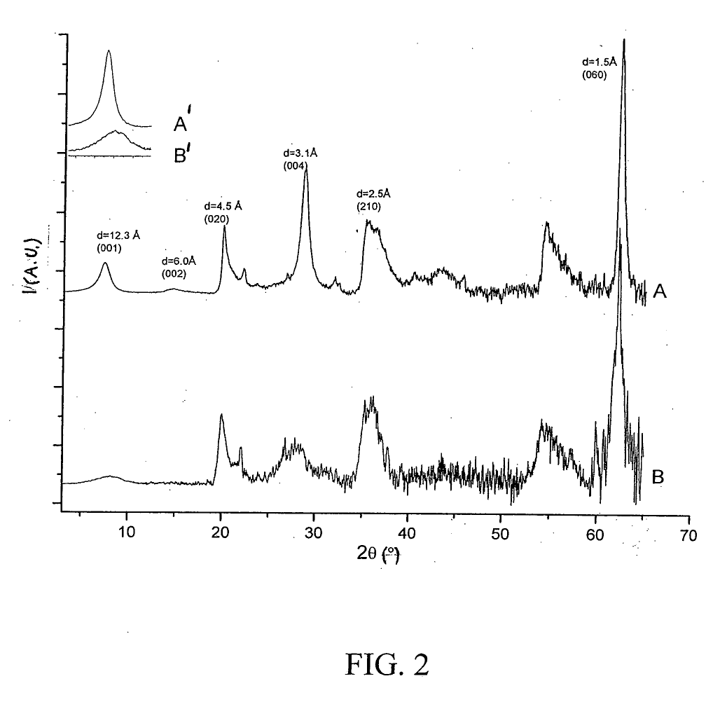

The obtained X-Ray powder diffraction patterns were reported in FIG. 2 [abscissa axis diffraction angles (2θ) expressed in degrees (°); ordinate axis intensity expressed in arbitrary units (A.U.)] wherein:
A: is the X-Ray powder diffraction pattern of the non-mechanically treated Cloisite® Na (comparative) [A′ represents an expanded view of peak (001)];
B: is the X-Ray powder diffraction pattern of the mechanically treated Cloisite® Na obtained as disclosed above [B′ represents an expanded view of peak (001)].

The X-ray powder diffraction (XRPD) patterns (A) and (B) were used to determine both the X-ray intensity ratio (R) and the delamination index (DI) as defined above. The obtained data were the following:
X-ray intensity ratio (R)=11;
delamination index (DI)=61%.

Moreover, the X-ray powder diffraction (XRPD) patterns (A) and (B) also show the d-spacing value which was calculated using the following formula:

d−spacing=λ/2 sin θ

in which λ is the wavelength of the Kα radiation of Cu (average of Kα1 and Kα2) equal to 1.54178 Å. The d-spacing value corresponds to the value of the distance between the parallel crystal planes of the layered material. In particular, said value is the average distance between the contiguous layers of the layered material.

### EXAMPLE 2

### Preparation of the Layered Material

10.0 g of Dellite® 67G (organo-modified montmorillonite belonging to the smectite family from Laviosa Chimica Mineraria S.p.A.) were added to a 0.300 l centrifugal ball-mill (Eatchs type, from Italscientifica S.p.A.), loaded with 2 ceramic balls having a diameter of 29.4 mm and 2 ceramic balls having 18.6 mm diameter. The mixture was ground, for 240 hours, with a rotating speed of 102 rpm, at ambient temperature (23° C.). 9.5 g of solid product were obtained.

The obtained powder was subjected to a average particle size measurement. To this aim 6 g of the obtained powder was dispersed in 60 ml of isopropyl alcohol and was maintained under stirring, at room temperature (23° C.), for 3 hours. The obtained dispersion was loaded to a particle size analyzer (Micrometric Sedigraph 5100). The average particle size (D50) was 0.8 μm.

Moreover, the BET surface area of the obtained powder was measured according to Standard ISO 5794-1:2005. The BET surface area was 3.8 m²/g.

The obtained product was subjected to X-ray powder diffraction (XRPD) analysis. The analysis was performed by using a Bruker D8 automatic diffractometer for powder, equipped with Göbel-mirror monochromator.

Instrumental and measuring conditions were the following: CuKα radiation; 40 kV/20 mA voltage/current; divergence and dectector slits of 1.0°, 0.6° and 0.8°, 0.05° 2θ step, using a time for step of 3 s, diffraction angle (2θ) from 20 to 800.

For comparative purposes a sample of a non-mechanically treated Dellite® 67G was also subjected to a X-ray powder diffraction (XRPD)analysis.

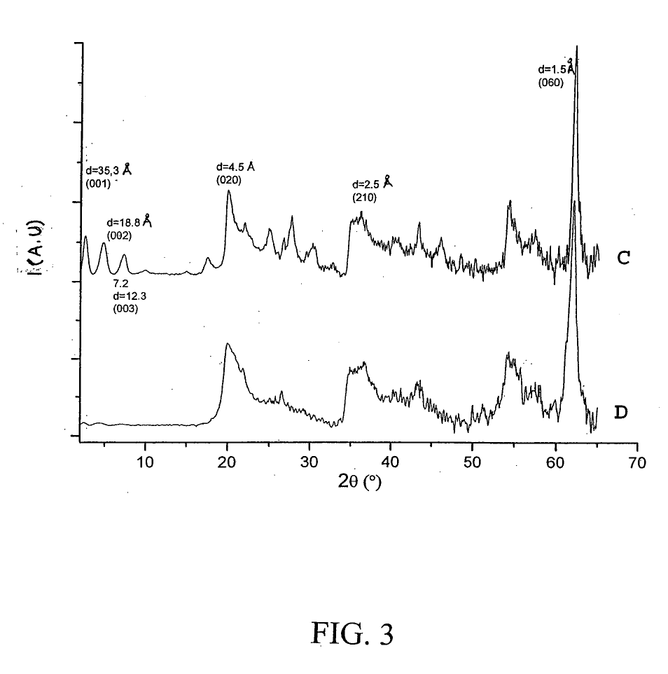

The obtained X-Ray powder diffraction patterns were reported in FIG. 3 [abscissa axis diffraction angles (2θ) expressed in degrees (°); ordinate axis intensity expressed in arbitrary units (A.U.)] wherein:
C: is the X-Ray powder diffraction pattern of the non-mechanically treated Dellite® 67G (comparative);
D: is the X-Ray powder diffraction pattern of the mechanically treated Dellite® 67G obtained as disclosed above.

The X-ray powder diffraction (XRPD) patterns (C) and (D) were used to determine both the X-ray intensity ratio (R) and the delamination index (DI) as defined above. The obtained data were the following:
X-ray intensity ratio (R)=1;
delamination index (DI)=95%.

Moreover, the X-ray powder diffraction (XRPD) patterns (C) and (D) also show the d-spacing value which was calculated using the following formula:

d−spacing=λ/2 sin θ

in which λ is the wavelength of the Kα radiation of Cu (average of Kα1 and Kα2) equal to 1.54178 Å. The d-spacing value corresponds to the value of the distance between the parallel crystal planes of the layered material. In particular, said value is the average distance between the contiguous layers of the layered material.

### EXAMPLES 3-6

### Preparation of the Elastomeric Compositions

The elastomeric compositions given in Table 1 were prepared as follows (the amounts of the various components are given in phr).

All the components, except sulfur and accelerator (DCBS), were mixed together in an internal mixer (model Pomini PL 1.6) for about 5 min (1^{st} Step). As soon as the temperature reached 145±5° C., the elastomeric composition was discharged. The sulfur and accelerator (DCBS) were then added and mixing was carried out in an open roll mixer (2^{nd} Step).

TABLE 1

| | | | | |
|---|---|---|---|---|
| EXAMPLE | 3 (*) | 4 (*) | 5 | 6 |

1^{st} STEP

| | | | | |
|---|---|---|---|---|
| IR | 100 | 100 | 100 | 100 |
| Dellite ® | 10 | — | — | — |
| 67G | | | | |
| Cloisite ® | — | 5.5 | — | — |
| Na | | | | |
| Compound of | — | — | 5.5 | — |
| Example 1 | | | | |
| Compound of | — | — | — | 10 |
| Example 2 | | | | |
| Arquad ® HC | — | 4.5 | 4.5 | — |
| Pastilles | | | | |
| N326 | 50 | 50 | 50 | 50 |
| Stearic | 2.0 | 2.0 | 2.0 | 2.0 |
| acid | | | | |
| Zinc Oxide | 4.0 | 4.0 | 4.0 | 4.0 |
| Antioxidant | 2.0 | 2.0 | 2.0 | 2.0 |
| X50S ® | 4.0 | 4.0 | 4.0 | 4.0 |

2^{nd} STEP

| | | | | |
|---|---|---|---|---|
| DCBS | 1.8 | 1.8 | 1.8 | 1.8 |
| Sulfur | 2.0 | 2.0 | 2.0 | 2.0 |

(*): comparative.
IR: cis-1,4-polyisoprene (SKI3 - Nizhnekamskneftechim Export);
Dellite ® 67G: organo-modified montmorillonite belonging to the smectite family (Laviosa Chimica Mineraria S.p.A.);
Cloisite ® Na: natural montmorillonite belonging to the smectite family (Southern Clay S.p.A.);
Arquad ® HC Pastilles: di(hydrogenated tallow)-dimethylammonium chloride (Akzo Nobel);
N326: carbon black;
Antioxidant: phenyl-p-phenylenediamine;
X50S ®: silane coupling agent comprising 50% by weight of carbon black and 50% by weight of bis(3-triethoxysilylpropyl)tetrasulphide (Degussa-Hüls);
DCBS (accelerator): benzothiazyl-2-dicyclohexyl-sulfenamide (Vulkacit ® DZ/EGC - Bayer).

The crosslinkable elastomeric compositions disclosed above were subjected to “scorch time” measurement, at 127° C., according to Standard ISO 289-2:1994. The obtained data are given in Table 2.

The static mechanical properties according to Standard ISO 37:1994 were measured on samples of the abovementioned elastomeric compositions vulcanized at 170° C., for 10 min. The results obtained are given in Table 2.

Table 2 also shows the dynamic mechanical properties, measured using an Instron dynamic device in the traction-compression mode according to the following methods. A test piece of the crosslinked elastomeric composition (vulcanized at 170° C., for 10 min) having a cylindrical form (length=25 mm; diameter=12 mm), compression-preloaded up to a 10% longitudinal deformation with respect to the initial length, and kept at the prefixed temperature (23° C., 70° C., or 100° C.) for the whole duration of the test, was submitted to a dynamic sinusoidal strain having an amplitude of +3.5% with respect to the length under pre-load, with a 100 Hz frequency. The dynamic mechanical properties are expressed in terms of dynamic elastic modulus (E′) and Tan delta (loss factor) values. The Tan delta value is calculated as a ratio between viscous modulus (E″) and elastic modulus (E′).

Moreover, Table 2 also shows the dynamic mechanical properties, measured using a Monsanto R.P.A. 2000 rheometer. For this purpose, cylindrical test specimens with weights in the range of from 4.5 g to 5.5 g were obtained by punching from the crosslinked elastomeric composition (vulcanized at 170° C., for 10 min), and were subjected to the measurement of (G′) at 80° C., frequency 1 Hz, deformation 3% and 10%.

Finally, the tear resistance values were measured according to Standard ISO 34-1:2004 and are also given in Table 2.

TABLE 2

| EXAMPLE | 3 (*) | 4 (*) | 5 | 6 |
|---|---|---|---|---|
| Schorch time | 7.67 | 8.76 | 10.22 | 8.32 |
| (min) | | | | |

STATIC MECHANICAL PROPERTIES

| | | | | |
|---|---|---|---|---|
| 50% Modulus | 1.91 | 1.83 | 1.57 | 1.53 |
| (CA0.5) (MPa) | | | | |
| 100% Modulus | 3.53 | 3.43 | 2.85 | 2.74 |
| (CA1) (MPa) | | | | |
| 300% Modulus | 13.15 | 13.58 | 11.57 | 12.08 |
| (CA3) (MPa) | | | | |
| CA3/CA1 | 3.725 | 3.959 | 4.060 | 4.410 |
| Stress at | 17.46 | 17.99 | 19.50 | 18.29 |
| break (MPa) | | | | |
| Elongation at | 409.3 | 410.0 | 468.6 | 441.0 |
| break (%) | | | | |

DYNAMIC MECHANICAL PROPERTIES (Instron)

| | | | | |
|---|---|---|---|---|
| E′ (23°) | 9.634 | 9.007 | 7.951 | 7.843 |
| E′ (70°) | 7.105 | 6.995 | 6.131 | 6.382 |
| E′ (100°) | 6.526 | 6.480 | 5.681 | 5.875 |
| ΔE′ (23° C.- | 3.108 | 2.527 | 2.270 | 1.970 |
| 100° C.) | | | | |
| Tan delta | 0.235 | 0.225 | 0.206 | 0.206 |
| (23°) | | | | |
| Tan delta | 0.162 | 0.147 | 0.146 | 0.132 |
| (70°) | | | | |
| Tan delta | 0.132 | 0. 122 | 0.119 | 0.108 |
| (100°) | | | | |

DYNAMIC MECHANICAL PROPERTIES (R.P.A. 2000 rheometer)

| | | | | |
|---|---|---|---|---|
| G′ (3%) (MPa) | 1.503 | 1.598 | 1.730 | 1.813 |
| G′ (10%) (MPa) | 1.048 | 1.089 | 1.253 | 1.286 |
| Tan delta (3%) | 0.235 | 0.211 | 0.176 | 0.163 |
| Tan delta (10%) | 0.232 | 0.226 | 0.176 | 0.178 |
| Tear | 64.3 | 70.0 | 118.0 | 92.0 |
| resistance | | | | |

(*): comparative.

1-49. (canceled)

50. A tire comprising at least one structural element comprising a crosslinked elastomeric material obtained by crosslinking a crosslinkable elastomeric composition comprising:
(a) at least one elastomeric polymer; and
(b) at least one layered material, said layered material having an individual layer thickness of 0.2 nm to 30 nm;
wherein said layered material shows, in an X-ray powder diffraction pattern, an X-ray intensity ratio (R) lower than or equal to 20, when defined according to the following formula:
(R)=[A₍₀₀₁₎/A₍ₕₖ₀₎ₘₐₓ]×100
wherein:
A₍₀₀₁₎ is the area of the peak (001); and
A₍ₕₖ₀₎ₘₐₓ is the area of the most intense peak (hk0), at least one of h or k being different from 0.

51. The tire according to claim 50, wherein said layered material has an individual layer thickness of 0.3 nm to 15 nm.

52. The tire according to claim 51, wherein said layered material has an individual layer thickness of 0.5 nm to 2 nm.

53. The tire according to claim 50, wherein said X-ray intensity ratio (R) is lower than or equal to 15.

54. The tire according to claim 53, wherein said X-ray intensity ratio (R) is lower than or equal to 10.

55. The tire according to claim 54, wherein said X-ray intensity ratio (R) is lower than or equal to 5.

56. The tire according to claim 50, comprising:
a carcass structure of a substantial toroidal shape, having opposite lateral edges associated with respective right-hand and left-hand bead structures, said bead structures comprising at least one bead core and at least one bead filler;
a belt structure applied in a radially external position with respect to said carcass structure;
a tread band radially superimposed on said belt structure; and
a pair of sidewalls applied laterally on opposite sides with respect to said carcass structure;
wherein said structural element is a tread band.

57. The tire according to claim 50, wherein said layered material shows, in an X-ray powder diffraction pattern, a delamination index (DI) higher than or equal to 10%, said delamination index being defined according to the following formula:
(DI)=[1−(1₀₀₁/I⁰₀₀₁)]×100
wherein:
I₍₀₀₁₎ is the intensity of the peak (001) of a mechanically treated layered material; and
I⁰₍₀₀₁₎ is the intensity of the peak (001) of a non-mechanically treated layered material;
said I₍₀₀₁₎ and I⁰₍₀₀₁₎ being defined by the following formulae:
I₍₀₀₁₎=A₍₀₀₁₎/A₍ₕₖ₀₎
I⁰₍₀₀₁₎=A^{o}₍₀₀₁₎/A⁰₍ₕₖ₀₎
wherein:
A₍₀₀₁₎ is the area of the peak (001) of the mechanically treated layered material;
A⁰₍₀₀₁₎ is the area of the peak (001) of the non-mechanically treated layered material;
A₍ₕₖ₀₎ is the area of a peak (hk0), or of a most intense peak (hk0), at least one of h or k being different from 0, of the mechanically treated layered material; and
A⁰₍ₕₖ₀₎ is the area of a peak (hk0), or of a most intense peak (hk0), at least one of h or k being different from 0, of the non-mechanically treated layered material.

58. The tire according to claim 57, wherein said layered material shows, in an X-ray powder diffraction pattern, a delamination index (DI) higher than or equal to 50%.

59. The tire according to claim 58, wherein said layered material shows, in an X-ray powder diffraction pattern, delamination index (DI) higher than or equal to 90%.

60. The tire according to claim 50, wherein said layered material has a BET surface area, measured according to Standard ISO 5794-1:2005, of 1 m²/g to 200 m²/g.

61. The tire according to claim 60, wherein said layered material has a BET surface area, measured according to Standard ISO 5794-1:2005, of 2 m²/g to 150 m²/9.

62. The tire according to claim 60, wherein said layered material has a BET surface area, measured according to Standard ISO 5794-1:2005, of 3 m²/g to 110 m²/g.

63. The tire according to claim 50, wherein said layered material has an average particle size lower than or equal to 70 μm.

64. The tire according to claim 63, wherein said layered material has an average particle size lower than or equal to 30 μm.

65. The tire according to claim 64, wherein said layered material has an average particle size lower than or equal to 10 μm.

66. The tire according to claim 65, wherein said layered material has an average particle size lower than or equal to 5 μm.

67. The tire according to claim 50, wherein said elastomeric polymer (a) is selected from (a₁) diene elastomeric polymers.

68. The tire according to claim 67, wherein said diene elastomeric polymers (a₁) have a glass transition temperature below 20° C.

69. The tire according to claim 67, wherein said diene elastomeric polymers (a₁) are selected from: natural or synthetic cis-1,4-polyisoprene, 3,4-polyisoprene, polybutadiene, halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

70. The tire according to claim 50, wherein said elastomeric polymer (a) is selected from (a₂) elastomeric polymers of one or more monoolefins with an olefinic comonomer or derivatives thereof.

71. The tire according to claim 70, wherein said elastomeric polymers (a₂) are selected from: ethylene/propylene copolymers or ethylene/propylene/diene copolymers; polyisobutene; butyl rubbers; halobutyl rubbers; chlorobutyl rubbers; bromobutyl rubbers; or mixtures thereof.

72. The tire according to claim 50, wherein said layered material (b) is obtained by milling at least one pristine layered material.

73. The tire according to claim 50, wherein said layered material (b) is obtained by milling at least one layered material modified with at least one alkyl ammonium or alkyl phosphonium salt.

74. The tire according to claim 50, wherein said layered material (b) is obtained by milling a mixture comprising:
at least one pristine layered material; and
at least one alkyl ammonium or alkyl phosphonium salt.

75. The tire according to claim 72 wherein said milling is a dry milling.

76. The tire according to claim 50, wherein said layered material is selected from phyllosilicates, smectites, montmorillonite, bentonite, nontronite, beidellite, volkonskoite, hectorite, saponite, sauconite, vermiculite, haloisite, sericite, aluminate oxides, hydrotalcite, or mixtures thereof.

77. The tire according to claim 73, wherein said alkyl ammonium or alkyl phosphonium salt is selected from quaternary ammonium or phosphonium salts having general formula (I): 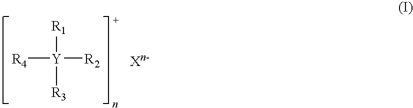
wherein:
Y represents N or P;
R₁, R₂, R₃ and R₄, which may be the same or different from each other, represent a linear or branched C₁-C₂₀ alkyl or hydroxyalkyl group; a linear or branched C₁-C₂₀ alkenyl or hydroxyalkenyl group; an —R₅—SH or —R₅—NH group wherein R₅ represents a linear or branched C₁-C₂₀ alkylene group; a C₆-C₁₈ aryl group; a C₇-C₂₀ arylalkyl or alkylaryl group; a C₅-C₁₈ cycloalkyl group; a cycloalkyl group containing a hetero atom, an oxygen atom, a nitrogen atom or a sulfur atom;
Xⁿ⁻ represents an anion, a chloride ion, a sulphate ion or a phosphate ion; and
n represents 1, 2 or 3.

78. The tire according to claim 50, wherein said at least one layered material (b) is present in the crosslinkable elastomeric composition in an amount of 3 phr to 120 phr.

79. The tire according to claim 78, wherein said at least one layered material (b) is present in the crosslinkable elastomeric composition in an amount of 5 phr to 80 phr.

80. The tire according to claim 50, wherein said crosslinkable elastomeric composition further comprises (c) at least one silane coupling agent.

81. The tire according to claim 80, wherein said silane coupling agent is selected from a silane having at least one hydrolizable silane group which is identified by the following general formula (II):
(R)₃Si—CₙH₂ₙ—X (II)
wherein the R groups, which may be the same or different from each other, are selected from: alkyl, alkoxy or aryloxy groups or from halogen atoms, on condition that at least one of the R groups is an alkoxy or aryloxy group; n is an integer of from 1 to 6, extremes included; X is a group selected from: nitroso, mercapto, amino, epoxide, vinyl, imide, chloro, —(S)ₘCₙH₂ₙ—Si—(R)₃, or —S—COR, wherein m and n are integers of from 1 to 6, extremes included, and the R groups are defined above.

82. The tire according to claim 80, wherein said silane coupling agent (c) is present in the crosslinkable elastomeric composition in an amount of 0 phr to 25 phr.

83. The tire according to claim 82, wherein said silane coupling agent (c) is present in the crosslinkable elastomeric composition in an amount of 0.5 phr to 10 phr.

84. The tire according to claim 83, wherein said silane coupling agent (c) is present in the crosslinkable elastomeric composition in an amount of 1 phr to 5 phr.

85. The tire according to claim 50, wherein said crosslinkable elastomeric composition further comprises (d) at least one alkyl ammonium or alkyl phosphonium salt.

86. The tire according to claim 85, wherein said at least one alkyl ammonium or alkyl phosphonium salt (d) is selected from quaternary ammonium or phosphonium salts having general formula (I): 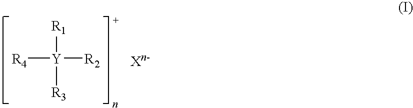
wherein:
Y represents N or P;
R₁, R₂, R₃ and R₄, which may be the same or different from each other, represent a linear or branched C₁-C₂₀ alkyl or hydroxyalkyl group; a linear or branched C₁-C₂₀ alkenyl or hydroxyalkenyl group; an —R₅—SH or —R₅—NH group, wherein R₅ represents a linear or branched C₁-C₂₀ alkylene group; a C₆-C₁₈ aryl group; a C₇-C₂₀ arylalkyl or alkylaryl group; a C₅-C₁₈ cycloalkyl group, a cycloalkyl group possibly containing a hetero atom, an oxygen atom, a nitrogen atom, or a sulfur atom;
Xⁿ⁻ represents an anion, a chloride ion, a sulphate ion or a phosphate ion; and
n represents 1, 2 or 3.

87. The tire according to claim 85, wherein said at least one alkyl ammonium or alkyl phosphonium salt (d) is present in the crosslinkable elastomeric composition in an amount of 0 phr to 50 phr.

88. The tire according to claim 87, wherein said at least one alkyl ammonium or alkyl phosphonium salt (d) is present in the crosslinkable elastomeric composition in an amount of 0.5 phr to 20 phr.

89. The tire according to claim 88, wherein said at least one alkyl ammonium or alkyl phosphonium salt (d) is present in the crosslinkable elastomeric composition in an amount of 1 phr to 10 phr.

90. The tire according to claim 50, wherein at least one reinforcing filler is added to the crosslinkable elastomeric composition in an amount of 0 phr to 120 phr.

91. The tire according to claim 90, wherein said at least one reinforcing filler is selected from carbon black, silica, alumina, aluminosilicates, calcium carbonate, kaolin, or mixtures thereof.

92. A crosslinkable elastomeric composition comprising:
(a) at least one elastomeric polymer; and
(b) at least one layered material, said layered material having an individual layer thickness of 0.2 nm to 30 nm;
wherein said layered material shows, in an X-ray powder diffraction pattern, an X-ray intensity ratio (R) lower than or equal to 20, when defined according to the following formula:
(R)=[A₍₀₀₁₎/A₍ₕₖ₀₎max]×100
wherein:
A₍₀₀₁₎ is the area of the peak (001); and
A₍ₕₖ₀₎ is the area of the most intense peak (hk0), at least one of h or k being different from 0.

93. The crosslinkable elastomeric composition according to claim 92, wherein said at least one elastomeric polymer (a) is selected from:
(a₁) diene elastomeric polymers; or
diene elastomeric polymers (a₁) having a glass transition temperature (T_{g}) below 20° C.; or
diene elastomeric polymers (a₁) selected from: natural or synthetic cis-1,4-polyisoprene, 3,4-polyisoprene, polybutadiene, halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof; or
(a₂) elastomeric polymers of one or more monoolefins with an olefinic comonomer or derivatives thereof; or
elastomeric polymers (a₂) selected from: ethylene/propylene copolymers or ethylene/propylene/diene copolymers; polyisobutene; butyl rubbers; halobutyl rubbers; chlorobutyl rubbers; or bromobutyl rubbers; or mixtures thereof.

94. The crosslinkable elastomeric composition according to claim 92 wherein said at least one layered material (b) is selected from: layered material having an individual layer thickness of 0.3 nm to 15 nm; or
a layered material having an X-ray intensity ratio (R) lower than or equal to 15; or
a layered material showing in an X-ray powder diffraction pattern, a delamination index (DI) higher than or equal to 10%, said delamination index being defined according to the following formula:
(DI)=[1−(I₀₀₁/I⁰₀₀₁)1×100
wherein:
I₍₀₀₁₎ is the intensity of the peak (001) of a mechanically treated layered material; and
I⁰₍₀₀₁₎ is the intensity of the peak (001) of a non-mechanically treated layered material; said I₍₀₀₁₎ and I⁰₍₀₀₁₎ being defined by the following formulae:
I₍₀₀₁₎=A₍₀₀₁₎/A₍ₕₖ₀₎
I⁰₍₀₀₁₎=A^{o}₍₀₀₁₎/A⁰₍ₕₖ₀₎
wherein:
A⁰₍₀₀₁₎ is the area of the peak (001) of the mechanically treated layered material;
A⁰₍₀₀₁₎ is the area of the peak (001) of the non-mechanically treated layered material;
A₍ₕₖ₀₎ is the area of a peak (hk0), or of a most intense peak (hk0), at least one of h or k being different from 0, of the mechanically treated layered material; and
A⁰₍ₕₖ₀₎ is the area of a peak (hk0), or of the most intense peak (hk0), at least one of h or k being different from 0, of the non-mechanically treated layered material; or
a layered material showing in an X-ray powder diffraction pattern, a delamination index (DI) higher than or equal to 50%; or
a layered material having a BET surface area, measured according to
Standard ISO 5794-1:2005, of 1 m²/g to 200 m²/g; or
a layered material having an average particle size lower than or equal to 70 μm; or
a layered material (b) obtained by milling at least one pristine layered material; or
a layered material (b) obtained by milling at least one layered material modified with at least one alkyl ammonium or alkyl phosphonium salt; or
a layered material (b) obtained by milling a mixture comprising:
at least one pristine layered material;
at least one alkyl ammonium or alkyl phosphonium salt; or
a layered material selected from phyllosilicates, smectites, montmorillonite, bentonite, nontronite, beidellite, volkonskoite, hectorite, saponite, sauconite, vermiculite, halloisite, sericite, aluminate oxides, hydrotalcite, or mixtures thereof; or
at least one layered material (b) present in the crosslinkable elastomeric composition in an amount of 3 phr to 120 phr.

95. The crosslinkable elastomeric composition according to claim 92, wherein said crosslinkable elastomeric composition further comprises (c) at least one silane coupling agent selected from
a silane having at least one hydrolizable silane group which is identified by the following general formula (II):
(R)₃Si—CₙH₂ₙ—X (II)
wherein the R groups, which may be the same or different from each other, are selected from: alkyl, alkoxy or aryloxy groups or from halogen atoms, on condition that at least one of the R groups is an alkoxy or aryloxy group; n is an integer of from 1 to 6, extremes included; X is a group selected from: nitroso, mercapto, amino, epoxide, vinyl, imide, chloro, —(S)ₘCₙH₂ₙ—Si—(R)₃, or —S—COR, wherein m and n are integers of from 1 to 6, extremes included, and the R groups are defined as above; or
a silane coupling agent (c) present in the crosslinkable elastomeric composition in an amount of 0 phr to 25 phr.

96. The crosslinkable elastomeric composition according to claim 92, wherein said crosslinkable elastomeric composition further comprises (d) at least one alkyl ammonium or alkyl phosphonium salt.

97. The crosslinkable elastomeric composition according to claim 92, wherein at least one reinforcing filler is added to the crosslinkable elastomeric composition in an amount generally from 0 phr to 120 phr, said reinforcing filler being selected from carbon black, silica, alumina, aluminosilicates, calcium carbonate, kaolin, or mixtures thereof.

98. A crosslinkable elastomeric manufactured product obtained by crosslinking the crosslinkable elastomeric composition according to claim 92.
